(19) United States
(12) Patent Application Publication
(10) Pub. No.: US 2004/0058307 A1
(43) Pub. Date: Mar. 25, 2004

(54) Transmitting method, transmitting apparatus, and transmitting program of pass/fail information of exams

(75) Inventors: Yasuo Tamura, Yokohama (JP); Koichi Nakazawa, Yokohama (JP); Hiroyasu Tanabe, Yokohama (JP); Ichiro Izaki, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/647,334

(22) Filed: Aug. 26, 2003

(30) Foreign Application Priority Data
Aug. 27, 2002 (JP) 2002-247721

(51) Int. Cl. G09B 7/00

(52) U.S. Cl. 434/362

(57) ABSTRACT

A method by a server of transmitting pass/fail information of an exam to an examinee terminal of an examinee via a network is disclosed. The method includes transmitting a confirmation mail asking whether to require the pass/fail information; receiving a response mail; recording reception time at which the server receives the response mail; determining, based on the reception time, an order in which to transmit a pass/fail information address at which the pass/fail information is located; and transmitting the pass/fail information address to a predetermined number of the examinee terminals depending on the transmission order and a load on the server. When the pass/fail information is released, the transmitting system can avoid the concentration of accesses to the pass/fail information from the examinees, and further avoid overload on the network and system.

### BACKGROUND OF THE INVENTION

1. Field of the Invention

The present invention relates to a transmitting method, a transmitting apparatus, and a transmitting system of pass/fail information about exams, for example, via a network.

2. Description of the Related Art

There are some systems to which examinees can enquire of pass/fail information of an entrance exam to a university, for example, via the Internet. For example, there is a web site in which examinees can browse the list of examinee numbers who have passed the exam. Another web site operates a database to which the examinees can input their examinee numbers and search the pass/fail information. Another system returns the pass/fail information in response to an enquiry from an examinee.

The problem of the above conventional systems is that, in a short period after the release of the pass/fail information, too many enquiries flood to the system, resulting in servers and networks being overloaded, systems failing, and/or E-mails not flowing smoothly.

The above web sites, if publicly accessible, cannot display personal information such as the examinee's current or affiliated school. Otherwise, the examinee may be required to input a cumbersome password to access the web sites and check the pass/fail information.

In the case that the examinee receives only his/her own pass/fail information directly, compared with the case that the examinee browses the list of examinees who have passed the exam, the examinee receives a greater psychological impact. The examinee cannot even estimate the passing rate of the exam.

### SUMMARY OF THE INVENTION

Accordingly, it is a general object of the present invention to provide a novel and useful transmitting method, transmitting apparatus, and transmitting program of pass/fail information via a network.

To achieve one or more of the above objects, a method by a server of transmitting pass/fail information indicating whether an examinee has passed or failed an exam to an examinee terminal of the examinee via a network, according to an aspect of the present invention, includes the steps of: transmitting a confirmation mail to the examinee terminal asking whether to require the pass/fail information; receiving a response mail returned by the examinee terminal in response to the confirmation mail; recording reception time at which the server receives the response mail; determining, based on the reception time, a transmission order by which to transmit to the examinee terminal a pass/fail information address in the network at which the pass/fail information is located; and transmitting the pass/fail information address to a predetermined number of the examinee terminals depending on the transmission order and a server load value indicating a load on the server and/or the network.

Several advantages are realized by the above steps in accordance with the present invention. When the pass/fail information is released, the transmitting system can avoid the excessive concentration of accesses to the pass/fail information via the network, and accordingly avoid network troubles such as delay in mail transmission and server system downtime.

A method of transmitting pass/fail information according to another aspect of the present invention includes the steps of: receiving a transmission request from the examinee terminal to transmit the pass/fail information based on a pass/fail information address in the network at which the pass/fail information is located; and transmitting, in response to reception of the transmission request, a plurality of examinee ID numbers around an examinee ID number of the examinee.

Accordingly, since the examinee can look for his/her examinee ID number one by one in the list of examinee ID numbers of examinees who have passed the exam, even if the examinee fails the exam, the examinee is not shocked as much as the examinee is when directly informed of the failure. The examinee can estimate the passing rate (or failure rate) of the exam based on the list.

A method of transmitting pass/fail information according to yet another aspect of the present invention includes the steps of: transmitting to the examinee terminal an enquiry to the examinee asking whether the examinee wishes to disclose the pass/fail information to other examinees; receiving a response by the examinee terminal to the transmitted enquiry; grouping, based on profile information of the plurality of examinees, examinees whose responses indicate a wish to disclose the pass/fail information to other examinees; and transmitting pass/fail information of the grouped examinees to the examinee terminals of the grouped examinees.

Accordingly, the examinee can receive the pass/fail information of other examinees who share the same profile information. The examinee can also estimate the passing rate of the examinees of the same profile information.

Other objects, features, and advantages of the present invention will be more apparent from the following detailed description when read in conjunction with the accompanying drawings.

### BRIEF DESCRIPTION OF THE DRAWINGS

FIG. 1 is a schematic diagram showing a construction of a transmitting system according to an embodiment of the present invention;

FIG. 2 is a flow chart showing processing of a server of the transmitting system according to an embodiment of the present invention to transmit mails to examinees asking whether the examinees wish to receive pass/fail information;

FIG. 3 is a flow chart showing processing of a server of the transmitting system according to an embodiment of the present invention to determine the order of examinees to transmit pass/fail information;

FIG. 4 is a flow chart showing processing of a server of the transmitting system according to an embodiment of the present invention to transmit a pass/fail information address;

FIG. 5 is a flow chart showing processing of a server of the transmitting system according to an embodiment of the present invention to transmit pass/fail information;

FIG. 6 is a flow chart showing processing of a server of the transmitting system according to an embodiment of the present invention to transmit pass/fail information of a plurality of examinees;

FIG. 7 is a flow chart showing processing of a server of the transmitting system according to an embodiment of the present invention to transmit pass/fail information of a group;

FIG. 8 illustrates an examinee profile table according to an embodiment of the present invention;

FIGS. 9A and 9B illustrate screens of an examinee terminal; and

FIGS. 10A through 10D illustrate other screens of an examinee terminal.

### DETAILED DESCRIPTION OF THE PREFERRED EMBODIMENTS

Preferred embodiments of the present invention are described in detail with reference to the drawings.

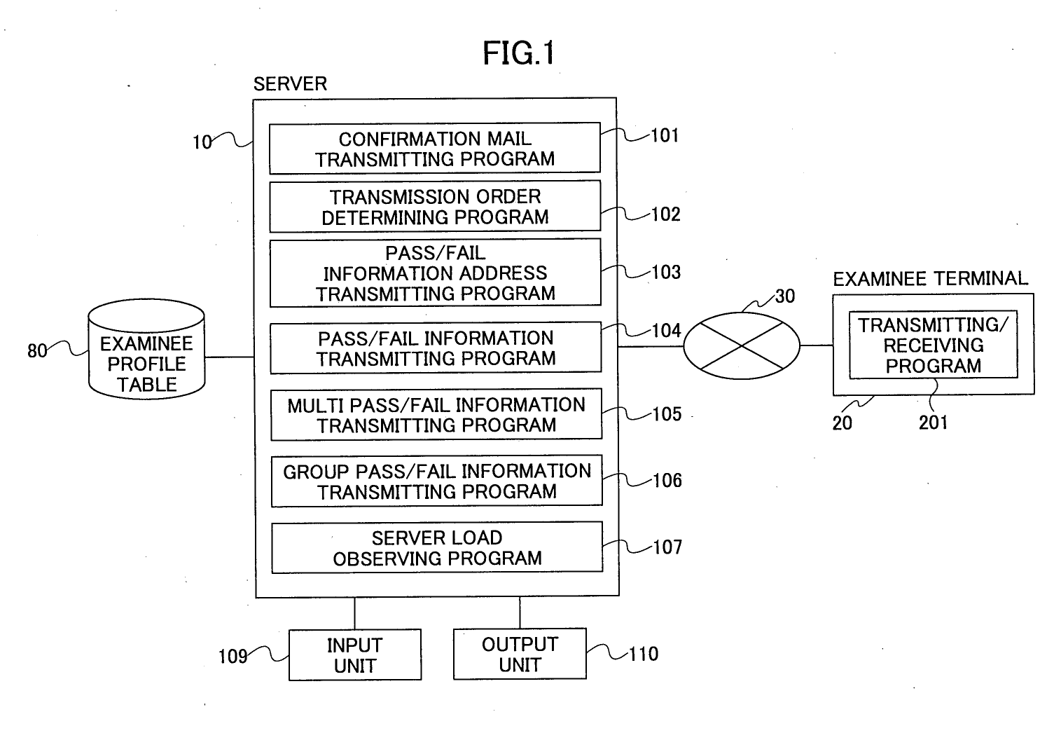

As shown in FIG. 1, a transmitting system according to an embodiment of the present invention includes a server 10 and an examinee terminal 20 connected via a network 30. The server 10 transmits, in response to reception of a request from the examinee terminal 20 of an examinee, pass/fail information of the examinee. Although only one examinee terminal 20 is shown in FIG. 1, the transmitting system may include a plurality of examinee terminals 20.

The server 10 is provided with the following: a confirmation mail transmitting program 101, a transmission order determining program 102, a pass/fail information address transmitting program 103, a pass/fail information transmitting program 104, a multi pass/fail information transmitting program 105, a group pass/fail information transmitting program 106, and a server load monitoring program 107. The server 10 is further provided with the following: an examinee profile table 80, an input unit 109, and an output unit 110.

The confirmation mail transmitting program 101 is a computer program that transmits a confirmation mail to each examinee asking whether the examinee wishes to receive the examinee's pass/fail information.

The transmission order determining program 102 is a computer program that receives a response mail from the examinee terminal 20 transmitted by the examinee in response to the confirmation mail, and, based on the time at which the response mail is received, determines an order in which to transmit a pass/fail information address at which the pass/fail information is located.

The pass/fail information address transmitting program 103 is a computer program that transmits, while the load on the server 10, for example, is less than a prescribed value, the pass/fail information address in accordance with the order determined by the transmission order determining program 102.

The pass/fail information transmitting program 104 is a computer program that, in response to a request for transmitting the pass/fail information transmitted from the examinee terminal 20, the request based on the pass/fail information address, transmits the pass/fail information to the examinee terminal 20.

The multi pass/fail information transmitting program 105 is a computer program that transmits, in response to a request for transmitting the pass/fail information transmitted from the examinee terminal 20, the request based on the pass/fail information address, a plurality of passing examinee numbers around and including the requesting examinee.

The group pass/fail information transmitting program 106 is a computer program that groups examinees, based on an examinee ID number for example (described below), that wish to disclose their pass/fail information to each other, and transmits the pass/fail information of the grouped examinees to the grouped examinees.

The server load monitoring program 107 is a computer program that monitors load statuses of the server 10 and/or the network 30. Although the server load monitoring program 107 is provided in the server 10 as shown in FIG. 1, the server load monitoring program 107 may instead be provided in an external apparatus so as to externally monitor the load states of the server 10 and/or the network 30. The externally provided server load monitoring program 107 can inform the server 10 of the load states.

The examinee terminal 20 is provided with a transmitting/receiving program 201, and exchanges various information, data, and mail with the server 10.

The examinee profile table 80 is a data table that stores correlating information of each examinee and information required for processing of the programs.

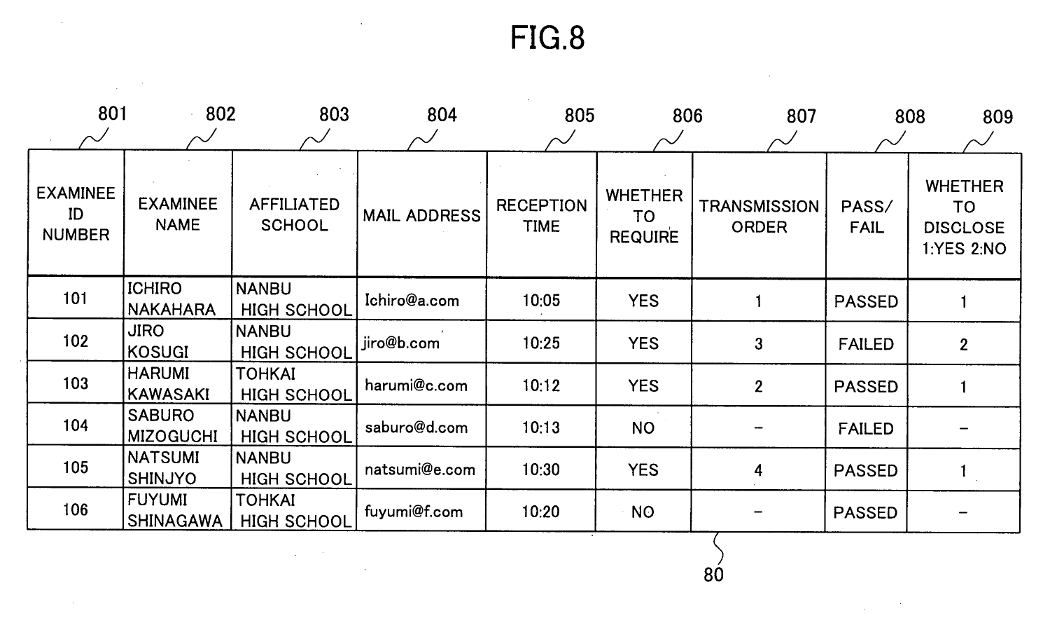

FIG. 8 illustrates an exemplary examinee profile table 80. A unique identification number is assigned to each examinee and is stored in EXAMINEE ID NUMBER 801. The name of each examinee is stored in EXAMINEE NAME 802. An affiliated school and mail address of each examinee are stored in AFFILIATED SCHOOL 803 and MAIL ADDRESS 804, respectively. The transmission order determining program 102 stores a time at which it receives the response mail and whether each examinee requires the pass/fail information in RECEPTION TIME 805 and WHETHER TO REQUIRE 806, respectively. The order in which to transmit the pass/fail information determined by the transmission order determining program 102 based on the reception time 805 is stored in TRANSMISSION ORDER 807. PASS/FAIL 808 indicates whether each examinee has passed or failed the exam. The group pass/fail information transmitting program 106 stores a response from each examinee to an enquiry whether to disclose the pass/fail information in WHETHER TO DISCLOSE 809.

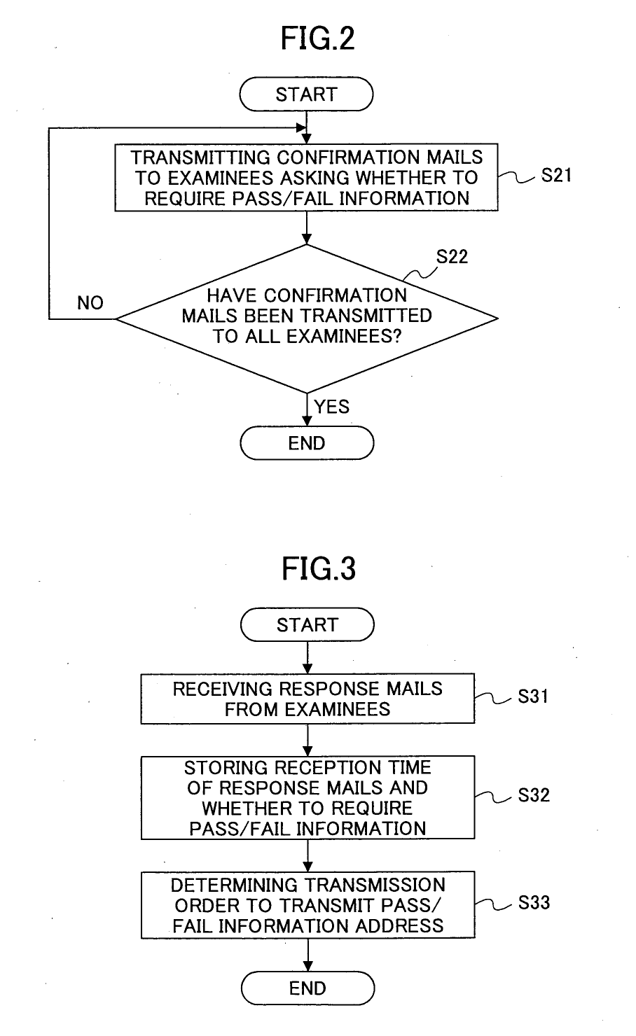

The operations of the transmitting system according to an embodiment of the present invention are described below with reference to flow charts shown in FIGS. 2-7 and the examinee profile table 80 shown in FIG. 8.

FIG. 2 is a flow chart for explaining processing of the confirmation mail transmitting program 101 to ask each examinee whether he/she requires his/her pass/fail information. In accordance with the present invention, with this processing, no information needs to be transmitted to examinee terminals 20 of non-requiring examinees. Accordingly, the total number of mails is reduced, and the load on the server 10 and/or the network 30 may be reduced.

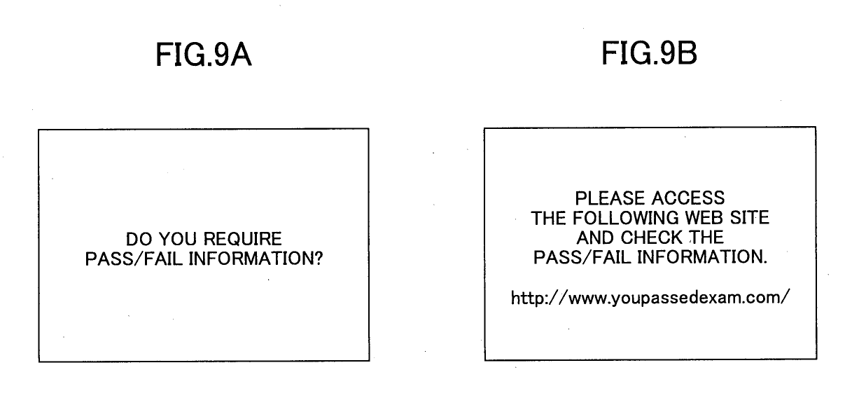

In step S21, with reference to mail address 804 of the examinee profile table 80 shown in FIG. 8, a confirmation mail is transmitted to each examinee asking whether he/she wishes to receive pass/fail information. FIG. 9A illustrates an exemplary transmission of a confirmation mail message.

In step S22, a determination is made whether the confirmation mail has been sent to all examinees based on the examinee profile table 80. If the confirmation mail has not yet been sent to all examinees, the confirmation mail is transmitted to remaining examinees based on the examinee profile table 80. If the confirmation mail has already been sent to all examinees, this processing ends.

FIG. 3 is a flow chart for explaining processing of the transmission order determining program 102 to determine the order in which to transmit the pass/fail information address in the network at which the pass/fail information is located based on the response mail returned by the examinees in response to the confirmation mail.

In step S31, the response mail from an examinee is received.

In step S32, the reception time of the response mail and whether the examinee requires the pass/fail information are stored in the RECEPTION TIME 805 and the WHETHER TO REQUIRE 806, respectively, based on the mail address for example of the sender of the response mail.

In step S33, the order in which to transmit the pass/fail information address to the examinees who wish to receive pass/fail information is determined based on the reception time stored in RECEPTION TIME 805, and is stored in TRANSMISSION ORDER 807. Accordingly, in this embodiment of the invention, the order of transmission is determined in accordance with the order of the reception of the response mail.

The order of transmission may instead be determined in accordance with how quick the examinee responds to the confirmation mail. Such a method ensures service on a “first come, first served” basis even in a case where transmitting the confirmation mails requires considerable time. The quickness of the examinee's response may be determined by approximating the time period from the transmission of the confirmation mail (to be recorded in the examinee profile table, for example, although not shown in FIG. 8) to the reception of the response mail.

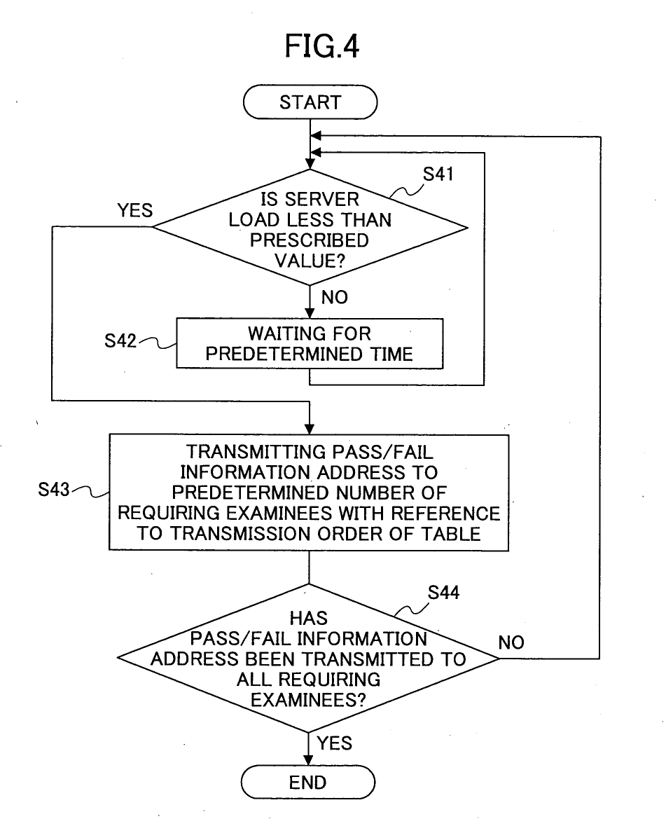

FIG. 4 is a flow chart for explaining processing by the pass/fail information address transmitting program 103 to transmit the pass/fail information address to the examinees.

In step S41, a determination is made whether a value (server load value) indicating the load state of the server 10 measured by the server load monitoring program 107 is less than a predetermined value. If the server load value is equal to or more than the predetermined value, the server 10 does not process the transmission and waits for a predetermined time in step S42. If the server load value is less than the predetermined value, step S43 is performed.

As will be appreciated, the server load value does not necessarily indicate only the load state of the server 10. The server load value may alternatively indicate the load state of the network 30 or the load state of both the server 10 and the network 30. As used herein the “server load value” is a generic term meaning such values.

In step S43, the pass/fail information address is transmitted for example via the mail address 804 to the examinees who wish to receive the pass/fail information by referring to the transmission order in the TRANSMISSION ORDER 807 of the examinee profile table 80. FIG. 9B illustrates an exemplary transmission in the way of a screen of the pass/fail information address.

In step S44, a determination is made whether the pass/fail information address has been transmitted to all examinees who require the pass/fail information address. If there remains a requiring examinee/examinees to whom the pass/fail information address has not been transmitted, the process returns to step S41. If the pass/fail information address has been transmitted to all of the requiring examinees, the processing ends.

In the embodiment shown in FIG. 4, in step S43, if the server load value is less than the predetermined value, the next step of transmitting the pass/fail information address to a predetermined number of examinees is performed every time. One can adjust the frequency at which the server load value is monitored and the determination of whether the measured server load value is less than the predetermined value by, for example, changing the number of examinees to whom the pass/fail information address is transmitted in a batch.

Although not shown, the number of examinees to whom the pass/fail information is transmitted in a batch may be changed based on the server load value. For example, if the server load value is equal to or more than 0 and less than 40, the pass/fail information address is transmitted to 10 examinees. If equal to or more than 40 and less than 80, the pass/fail information address is transmitted to 5 examinees. If equal to or more than 80, the pass/fail information address is transmitted to 0 examinees; that is, the pass/fail information address is not transmitted, and the server 10 waits for a predetermined time.

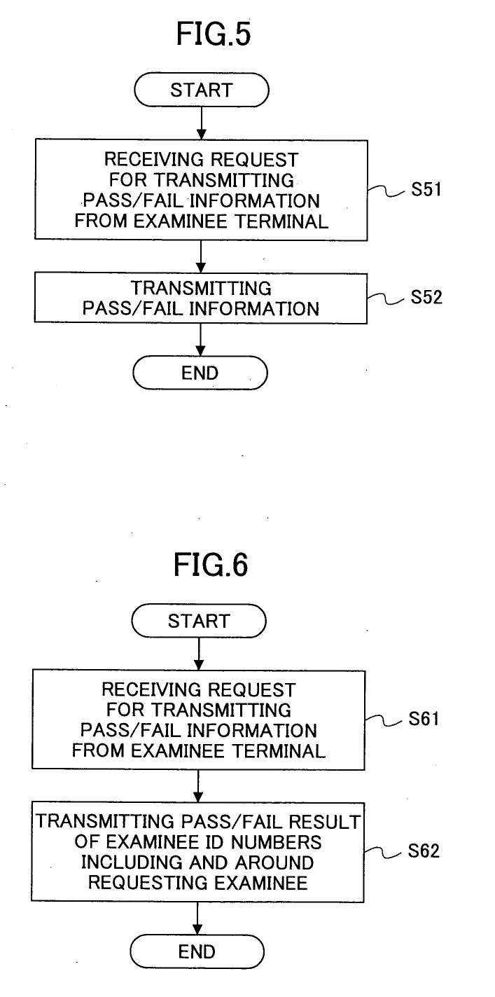

FIG. 5 is a flow chart for explaining processing of the pass/fail information transmitting program 104 to transmit the pass/fail information in response to reception of a request for transmitting the pass/fail information form an examinee terminal 20.

The examinee terminal 20 makes a connection with the server 10 via the network 30 based on the pass/fail information address shown in FIG. 9B, for example, and requests the server 10 to transmit the pass/fail information. In step S51, the server 10 receives the request for transmitting the pass/fail information. When transmitting the request, the examinee inputs his/her examinee ID number, for example, to identify himself/herself. In the present embodiment, the examinee ID number is included in the request, although it will be appreciated that other identifying information may be in the request, for example, the examinee's mail address, affiliated school, and/or a user ID and/or password.

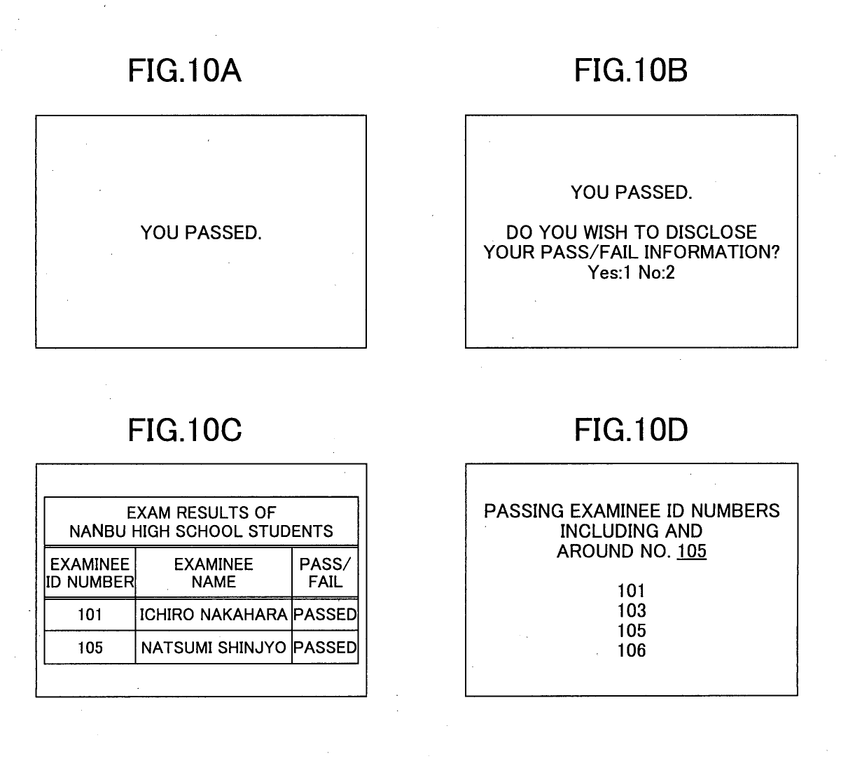

In step S52, the server 10 refers to the examinee ID number in EXAMINEE ID NUMBER 801 and the corresponding pass/fail result in PASS/FAIL 808 in the examinee profile table 80, and transmits the pass/fail information of the examinee to the examinee terminal 20. FIG. 10A illustrates an exemplary transmission in the way of a screen of the pass/fail information.

Although not shown in FIG. 5, before performing step S52, the server 10 may determine whether the examinee ID number included in the request from the examinee terminal 20 corresponds to the mail address from which the response mail is returned in order to protect the pass/fail information from a false or fraudulent access. If the examinee ID number included in the request does not correspond to the mail address, the server 10 may ignore the request or enter another process to handle such a false or fraudulent access.

FIG. 10A indicates the pass/fail result of solely the requesting examinee. A plurality of examinee ID numbers, however, may be indicated as shown in FIG. 10D so that the pass/fail result of a single examinee is not displayed. FIG. 6 is a flow chart for explaining processing by the multi pass/fail information transmitting program 105 according to such an embodiment.

Step S61 is identical to step S51 of FIG. 5. In step S62, a plurality of ID numbers of those examinees who have passed/failed the exam including and around the requesting examinee ID number received in step S61 are transmitted together by referring to EXAMINEE ID NUMBER 801 and PASS/FAIL 808 of the examinee profile table 80. In the exemplary illustrated embodiment, the requesting examinee 105 passed as indicated in table 80 and, accordingly, the requesting examinee ID number 105 as well as the examinee ID numbers of other examinees around examinee ID number 105 who also passed are displayed.

The server 10 is provided with both the pass/fail information transmitting program 104 and the multi pass/fail information transmitting program 105 as shown in FIG. 1, but alternatively may be provided with either one of the programs. In the case that the server 10 is provided with both programs, one of the programs may be selected based on the request for transmitting the pass/fail information from the examinee terminal 20. For example, if the request includes information whether the examinee terminal 20 is a personal computer with a large display area or a cellar phone with a small display area, the program to be selected may be determined by such information. The examinee may be allowed to choose one of the programs, that is, the manner in which the pass/fail information is displayed.

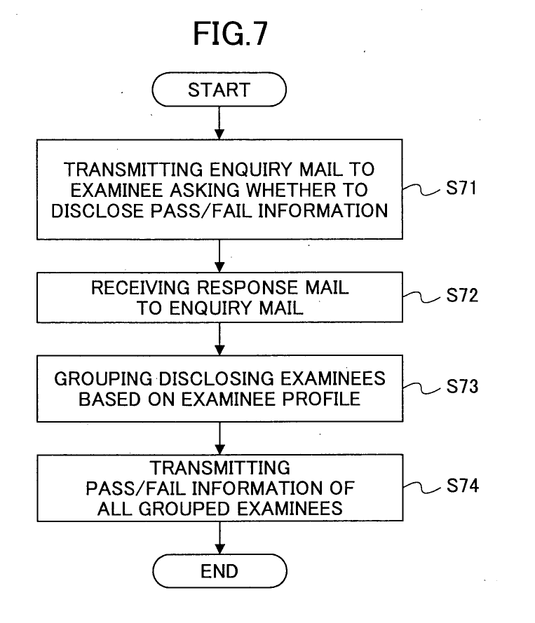

FIG. 7 is a flow chart for explaining processing by the group pass/fail information transmitting program 106. In this case, examinees who wish to disclose their pass/fail information to each other are grouped, and the pass/fail information of all the grouped examinees is transmitted to each grouped examinee.

In step S71, an enquiry is transmitted to the examinee terminal 20 asking whether the examinee wishes to disclose his/her pass fail information to others. The enquiry may be made simultaneously at the transmission of the pass/fail information in step S52, or may be made after the pass/fail information is transmitted. FIG. 10B illustrates an exemplary transmission of an enquiry displayed on the screen of an examinee terminal 20.

In step S72, the server 10 receives a response to the enquiry from the examinee terminal 20. The response is recorded in WHETHER TO DISCLOSE 809 in the examinee profile table 80.

In step S73, the examinees who wish to disclose their pass/fail information are grouped based on the information of the examinee profile table 80. For example, an examinee “Natsumi Shinjyo” wishes to disclose her pass/fail result, and further wishes to receive the pass/fail information of other examinees of the same affiliate school. In this embodiment, the server 10 refers to AFFILIATED SCHOOL 803 of “Natsumi Shinjyo”, and identifies her affiliated school as “Nanbu High School”. The server 10 searches examinees whose WHETHER TO DISCLOSE 809 is “1” and AFFILIATED SCHOOL 803 is “Nanbu High School”. The server 10 extracts and groups “Ichiro Nakahara” and “Natsumi Shinjyo”. The two of them constitute a group.

In step S74, the pass/fail information of the grouped examinees is transmitted to the examinee terminal 20.

According to the above embodiments, the present invention is applied to an entrance exam of a university. In the case of a qualification exam, the examinees may be grouped based on the company for which they are working instead of the affiliated school in step S73. Besides the information of the examinee profile table 80 shown in FIG. 8, various items of information such as birthplace, sex, and age may be used for the grouping of examinees.

Although not shown in the drawings, the server 10 and the examinee terminal 20 are computers which systems thereof are controlled by a Central Processing Unit (CPU). The computer includes a Random Access Memory (RAM), a Hard Disk Drive (HDD), a graphics processing unit, an input interface, and a communication interface connected to the CPU via a bus.

An Operating System (OS) and other programs run by the CPU are temporarily stored, at least partially, in the RAM. Various data required for processing by the CPU are also stored in the RAM. The OS, other programs, and data are stored in the HDD.

A monitor apparatus is connected to the graphics processing unit. The graphics processing unit displays an input screen, for example, on the monitor apparatus in accordance with an instruction from the CPU. A keyboard and a mouse, for example, are connected to the input interface. The input interface mediates a signal from the keyboard and the mouse to the CPU via the bus.

The communication interface is connected to the network 30. The communication interface exchanges data with the examinee terminal 20 via the network.

The confirmation mail transmitting program 101, the transmission order determining program 102, the pass/fail information address transmitting program 103, the pass/fail information transmitting program 104, the multi pass/fail information transmitting program 105, the group pass/fail information transmitting program 106, and the server load monitoring program 107 cause the above computer to function as a transmitting apparatus of pass/fail information in accordance with an embodiment of the invention.

The above computer programs may be stored in a computer readable recording medium such as a magnetic recording medium and a semiconductor memory. The above computer programs may be put in a distribution channel by being stored in a removable storage medium such as a Compact Disk Read Only Memory (CD-ROM) and a flexible disk, or may be downloaded via the network by being stored in a storage apparatus connected to a computer via the network. The above computer programs may be stored in the HDD, and when they are executed, the above computer programs are loaded to a main memory of the computer.

As described above, the transmitting system of pass/fail information according to an embodiment of the present invention controls the transmission of information indicating the location of the pass/fail information based on the load state of a server and/or network (i.e., a server load value). Accordingly, when the pass/fail information is released, the transmitting system can avoid the excessive concentration of accesses to the pass/fail information via the network, and accordingly avoid network troubles such as delay in mail transmission and server system downtime.

Additionally, since the examinee can look for his/her examinee ID number one by one in the list of examinee ID numbers of examinees who have passed the exam, even if the examinee fails the exam, the examinee is not shocked as much as the examinee is when directly informed of the failure. The examinee can estimate the passing rate (or failure rate) of the exam based on the list.

Additionally, the examinee can receive the pass/fail information of other examinees who share the same profile information such as the affiliated school. The examinee can also estimate the passing rate of the examinees of the same profile information.

The present invention is not limited to these embodiments, but various variations and modifications may be made without departing from the scope of the present invention.

This patent application is based on Japanese priority patent application No. 2002-247721 filed on Aug. 27, 2002, the entire contents of which are hereby incorporated by reference.

What is claimed is:

1. A method by a server of transmitting pass/fail information indicating whether an examinee has passed or failed an exam to an examinee terminal of said examinee via a network, comprising the steps of:
transmitting a confirmation mail to said examinee terminal asking whether to require said pass/fail information;
receiving a response mail returned by said examinee terminal in response to said confirmation mail;
recording reception time at which said server receives said response mail;
determining, based on said reception time, a transmission order by which to transmit to said examinee terminal a pass/fail information address in said network at which said pass/fail information is located; and
transmitting said pass/fail information address to a predetermined number of said examinee terminals depending on said transmission order and a server load value indicating a load on said server and/or said network.

2. The method as claimed in claim 1, further comprising the steps of:
receiving a transmission request for transmitting said pass/fail information transmitted from said examinee terminal, said transmission request based on said pass/fail information address; and
transmitting said pass/fail information in response to said transmission request.

3. A method by a server of transmitting pass/fail information indicating whether an examinee has passed or failed an exam to an examinee terminal of said examinee via a network, comprising the steps of:
receiving a transmission request for transmitting said pass/fail information transmitted from said examinee terminal, said transmission request based on a pass/fail information address in said network at which said pass/fail information is located; and
transmitting, in response to reception of said transmission request, a plurality of examinee ID numbers around an examinee ID number of said examinee.

4. A method by a server of transmitting pass/fail information indicating whether an examinee among a plurality of examinees has passed or failed an exam to an examinee terminal of said examinee via a network, comprising the steps of:
transmitting to said examinee terminal an enquiry to said examinee asking whether said examinee wishes to disclose said pass/fail information to other examinees;
receiving a response by said examinee terminal to said transmitted enquiry;
grouping, based on profile information of the plurality of examinees, examinees whose responses indicate a wish to disclose said pass/fail information to other examinees; and
transmitting pass/fail information of the grouped examinees to said examinee terminals of the grouped examinees.

5. A transmitting apparatus of pass/fail information indicating whether an examinee has passed or failed an exam to an examinee terminal, comprising:
a transmitting unit that transmits a confirmation mail to said examinee terminal asking whether to require said pass/fail information;
a receiving unit that receives a response mail returned by said examinee terminal in response to said confirmation mail;
a determining unit that records reception time at which said response mail is received and determines, based on said reception time, a transmission order by which to transmit to said examinee terminal a pass/fail information address at which said pass/fail information is located; and
a transmitting unit that transmits said pass/fail information address to a predetermined number of said examinee terminals depending on said transmission order and a load value indicating a load on said transmitting apparatus.

6. The transmitting apparatus as set forth in claim 5, wherein the transmitting unit transmits said pass/fail information address to the predetermined number of examinee terminals when the load value indicating the load on said transmitting apparatus is less than a predetermined value.

7. A computer program that causes a computer to function as:
a transmitting unit that transmits a confirmation mail to an examinee terminal used by an examinee asking whether said examinee requires pass/fail information indicating whether said examinee has passed or failed an exam;
a receiving unit that receives a response mail returned in response to said confirmation mail from said examinee terminal;
a determining unit that records reception time at which said response mail is received and determines, based on said reception time, a transmission order by which to transmit to said examinee terminal a pass/fail information address at which said pass/fail information is located; and
a transmitting unit that transmits said pass/fail information address to a predetermined number of said examinee terminals depending on said transmission order and a load value indicating a load or said computer.

8. The computer program as set forth in claim 7, wherein the transmitting unit transmits said pass/fail information address to the predetermined number of examinee terminals while the load value indicating the load on said computer is less than a predetermined value.

9. A computer readable recording medium storing a computer program that causes a computer to function as:
a transmitting unit that transmits a confirmation mail to an examinee terminal used by an examinee asking whether said examinee requires pass/fail information indicating whether said examinee has passed or failed an exam;
a receiving unit that receives a response mail returned in response to said confirmation mail from said examinee terminal;
a determining unit that records reception time at which said response mail is received and determines, based on said reception time, a transmission order by which to transmit to said examinee terminal a pass/fail information address at which said pass/fail information is located; and
a transmitting unit that transmits said pass/fail information address to a predetermined number of said examinee terminals depending on said transmission order and a load value indicating a load on said computer.

10. The computer readable recording medium as set forth in claim 9, wherein the transmitting unit transmits said pass/fail information address to the predetermined number of examinee terminals while the load value indicating the load on said computer is less than a predetermined value.
